(19) United States
(12) Patent Application Publication
(10) Pub. No.: US 2006/0158150 A1
(43) Pub. Date: Jul. 20, 2006

(54) Power supply device

(76) Inventor: Jen-Yen Yen, Yenpu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/034,840

(22) Filed: Jan. 14, 2005

(51) Int. Cl. H02J 7/00

(52) U.S. Cl. 320/103

(57) ABSTRACT

A power supply device includes a storage power circuit, which has a rechargeable battery, a power generating battery, which generates electricity to charge the rechargeable battery of the storage power circuit, an illuminator circuit to be controlled to give off light for illumination, a charging control circuit to be controlled to charge the rechargeable battery of an external device with electricity from the rechargeable battery of the storage power circuit, and a double-throw selector switch to be controlled to selectively connect the illuminator circuit or the charging control circuit to the storage power circuit.

### BACKGROUND OF THE INVENTION

1. Field of the Invention

The present invention relates to a power supply device and more particularly, to such a power supply device, which generates electricity to charge a rechargeable battery thereof, keeping the rechargeable battery in a saturated status for providing electricity for the working of an illuminator or for charging the rechargeable battery of an external device.

2. Description of the Related Art

Regular power supply devices include two types, namely, the AC adapter type power supply device, which rectifies AC power supply into DC power supply for working, and the battery type power supply device, which uses a rechargeable or non-rechargeable battery provide the necessary working voltage. An AC adapter type power supply device is usable only where AC city power supply is available. A battery type power supply device is workable anywhere, however it supplies a limited amount of battery power. When power lower, the user must replace the non-rechargeable battery with a new battery, or recharge the rechargeable battery with city power supply.

### SUMMARY OF THE INVENTION

The present invention has been accomplished under the circumstances in view. It is the main object of the present invention to provide a power supply device, which generates electricity to charge a rechargeable battery thereof for supply power supply to an illuminator or to charge the rechargeable battery of an external device.

To achieve this and other objects of the present invention, the power supply device comprises a power generating battery, a storage power circuit, an illuminator circuit, and a charging control circuit, wherein the storage power circuit is comprised of a resistor, a capacitor, a rechargeable battery, and a double-throw selector switch, the rechargeable battery being electrically connected to the illuminator circuit and the charging control circuit through the double-throw selector switch to provide the illuminator circuit and the charging control circuit with the necessary working voltage; the illuminator circuit is comprised of a resistor and a light emitting device for giving off light for illumination; the charging control circuit is comprised of an inductor, a diode, a capacitor, a control chip, and an electric plug adapted to electrically connect the charging control circuit to an external rechargeable battery to charge the external rechargeable battery; the power generating battery is electrically connected to the rechargeable battery of the storage power circuit and adapted to generate electricity for charging the rechargeable battery of the storage power circuit.

### BRIEF DESCRIPTION OF THE DRAWINGS

FIG. 1 is a circuit diagram of a power supply device according to the present invention.

FIG. 2A is a side view in section of a power generating battery for the power supply device according to the present invention.

FIG. 2B is a front plain view of the power generating battery for the power supply device according to the present invention.

### DETAILED DESCRIPTION OF THE PREFERRED EMBODIMENT

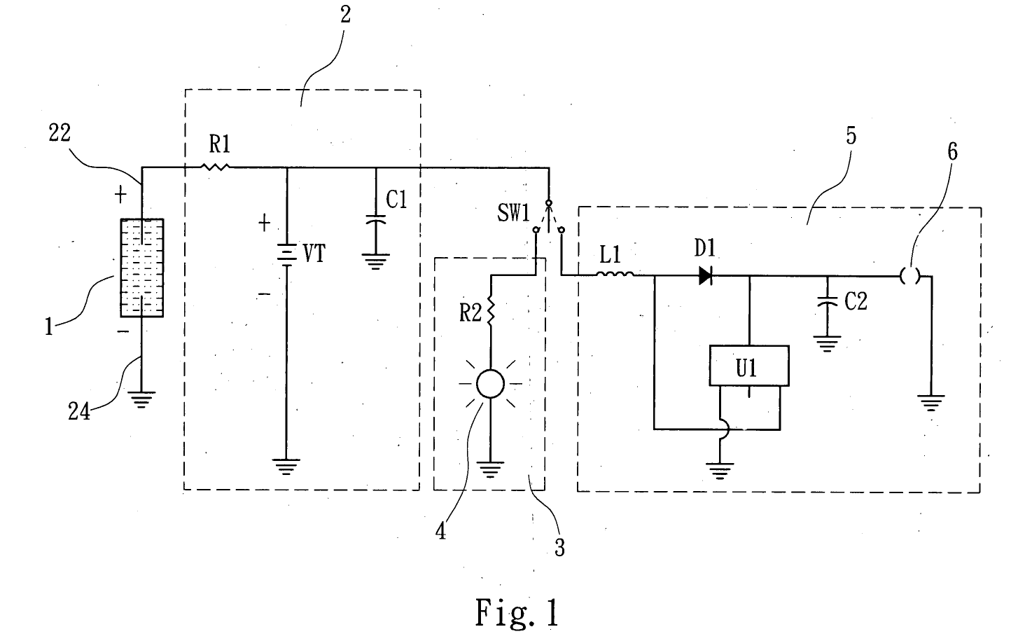

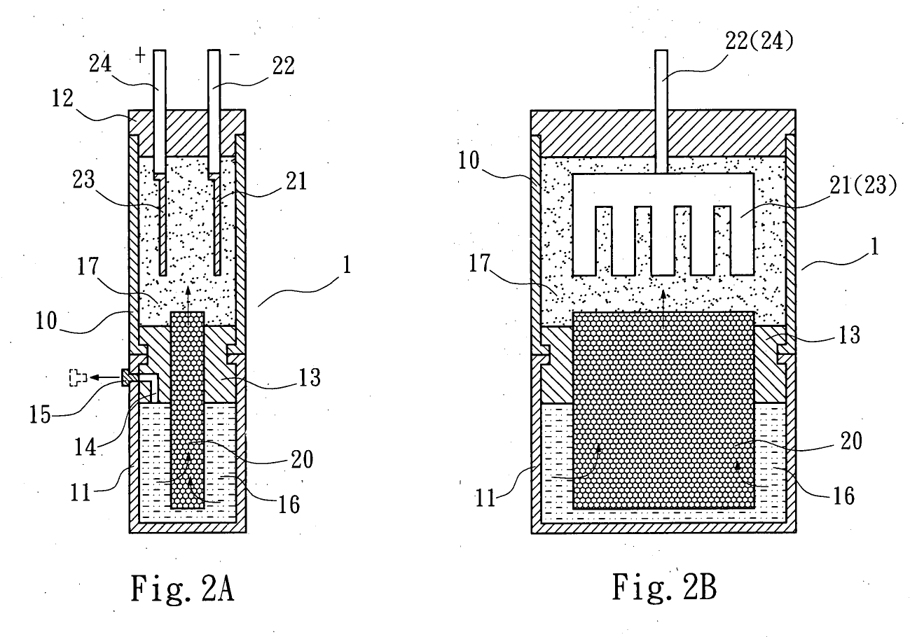

Referring to FIGS. 1, 2A and 2B, a power supply device in accordance with the present invention is shown comprising a power generating battery 1, a storage power circuit 2, an illuminator circuit 3, and a charging control circuit 5.

The storage power circuit 2 is comprised of a resistor R1, a capacitor C1, and a rechargeable battery VT. The rechargeable battery VT is electrically connected to the illuminator circuit 3 and the charging control circuit 5 to provide them with the necessary working voltage. The illuminator circuit 3 is comprised of a resistor R2 and a light emitting device 4 for giving off light for illumination. The light emitting device 4 can be a lamp bulb. The charging control circuit 5 is comprised of an inductor L1, a diode D1, a capacitor C2, a control chip U1, and an electric plug 6. By means of the electric plug 6, the charging control circuit 5 is connectable to an external rechargeable battery to charge the external rechargeable battery. Further, a double-throw selector switch SW1 is provided for selectively connecting the illuminator circuit 3 or the charging control circuit 5 to the storage power circuit 2 to have the storage power circuit 2 provide electricity to the illuminator circuit 3 or the charging control circuit 5.

The power generating battery 1 comprises an upper housing 10, a lower housing 11, a connecting member 13 connected between the upper housing 10 and the lower housing 11, a top cover 12 covered on the top side of the upper housing 10, water 16 filled in the lower housing 11, a salt and graphite power compound 17 filled in the upper housing 10, a cell compartment copper member 21 and a cell compartment aluminum-magnesium alloy member 23 respectively embedded in the salt and graphite power compound 17 inside the upper housing 10, a positive terminal 22 electrically connected to the cell compartment copper member 21 and upwardly extending out of the top cover 12, a negative terminal 24 electrically connected to the cell compartment aluminum-magnesium alloy member 23 and upwardly extending out of the top cover 12, an absorptive member 20 inserted through the connecting member 13 and partially embedded in the salt and graphite power compound 17 inside the upper housing 10 and partially dipped in water 16 inside the lower housing 11, a filling hole 14 extending through the peripheral wall of the lower housing 11 and the connecting member 13 in fluid communication with the holding space of the lower housing 11 for enabling the user to fill water 16 into the lower housing 11, and a stopper 15 adapted to seal the filling hole 14. The absorptive member 20 absorbs water 16 from the lower housing 11 to wet the salt and graphite power compound 17 in the upper housing 10, thereby causing an electric current to be generated through the cell compartment copper member 21 and the cell compartment aluminum-magnesium alloy member 23.

Referring to FIG. 1 again, the power generating battery 1 continuously generates electricity to charge the rechargeable battery VT of the storage power circuit 2, keeping the rechargeable battery VT in a saturated status. When the illumination mode is desired, operate the double-throw selector switch SW1 to electrically connect the illuminator circuit 3 to the storage power circuit 2, for enabling the illuminator circuit 3 to obtain the necessary working voltage to turn on the light emitting device 4. When wishing to charge an external rechargeable battery, for example, the rechargeable battery of a cellular telephone, connect the electric plug 6 of the charging control circuit 5 to the power input jack of the cellular telephone and then operate the double-throw selector switch SW1 to electrically connect the charging control circuit 5 to the storage power circuit 2, for enabling the charging control circuit 5 to charge the rechargeable battery of the cellular telephone with the electricity of the rechargeable battery VT of the storage power circuit 2.

As indicated above, the power supply device of the present invention comprises a power generating battery 1 and a rechargeable battery VT, and the power generating battery 1 generates electricity to charge the rechargeable battery VT to the saturated status. Therefore, it is not necessary to find city power supply for charging the rechargeable battery VT. The rechargeable battery VT can be continuously used to the end of its service life.

Referring to FIGS. 2A and 2B again, according to the principle of dry battery, the cell compartment copper member 21 and the cell compartment aluminum-magnesium alloy member 23 work with the salt and graphite power compound 17 to produce an electric flow, i.e., “electric current” when the salt and graphite power compound 17 is wetted. The absorptive member 20 (for example, sponge) absorbs water 16 from the lower housing 11 to wet the salt and graphite power compound 17 in the upper housing 10, thereby causing a flow of electrons, i.e., an electric current to be produced through the cell compartment copper member 21 and the cell compartment aluminum-magnesium alloy member 23. The electric current thus produced is transmitted through the positive terminal 22 and the negative terminal 24 to charge the rechargeable battery VT of the storage power circuit 2. Therefore, the rechargeable battery VT is frequently charged to the saturated status. Further, when water 16 is used up, the user can open the stopper 15 to fill water 16 through the filling hole 14 into the inside of the lower housing 11.

A prototype of power supply device has been constructed with the features of FIGS. 1, 2A and 2B. The power supply device functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A power supply device comprising a power generating battery, a storage power circuit, an illuminator circuit, and a charging control circuit, wherein:
said storage power circuit is comprised of a resistor, a capacitor, a rechargeable battery, and a double-throw selector switch, said rechargeable battery being electrically connected to said illuminator circuit and said charging control circuit through said double-throw selector switch to provide said illuminator circuit and said charging control circuit with the necessary working voltage;
said illuminator circuit is comprised of a resistor and a light emitting device for giving off light for illumination;
said charging control circuit is comprised of an inductor, a diode, a capacitor, a control chip, and an electric plug adapted to electrically connect said charging control circuit to an external rechargeable battery to charge the external rechargeable battery;
said power generating battery is electrically connected to the rechargeable battery of said storage power circuit and adapted to generate electricity for charging the rechargeable battery of said storage power circuit.

2. The power supply device as claimed in claim 1, wherein said power generating battery comprises an upper housing, a lower housing, a connecting member connected between said upper housing and said lower housing, a top cover covered on a top side of said upper housing, water filled in said lower housing, a salt and graphite power compound filled in said upper housing, a cell compartment copper member and a cell compartment aluminum-magnesium alloy member respectively embedded in said salt and graphite power compound inside said upper housing, a positive terminal electrically connected to said cell compartment copper member and upwardly extending out of said top cover, a negative terminal electrically connected to said cell compartment aluminum-magnesium alloy member and upwardly extending out of said top cover, an absorptive member inserted through said connecting member and adapted to absorb water from said lower housing and to wet said salt and graphite power compound.

3. The power supply device as claimed in claim 1, wherein said lower housing comprises a filling hole extending through a peripheral wall thereof and said connecting member in fluid communication with the inside of said lower housing for enabling the user to fill water into said lower housing, and a stopper adapted to seal said filling hole.
